(19) United States
(12) Patent Application Publication
(10) Pub. No.: US 2004/0160043 A1
(43) Pub. Date: Aug. 19, 2004

(54) Instrument panel system with hidden airbag door

(75) Inventors: Frank Litjens, Breda (NL); Lahoussaine Boutghrit, Bergen op Zoom (NL)

Correspondence Address: GENERAL ELECTRIC COMPANY, GE PLASTICS, ONE PLASTICS AVENUE, PITTSFIELD, MA, 01201, US

(73) Assignee: General Electric Company

(21) Appl. No.: 10/773,493

(22) Filed: Feb. 6, 2004

(30) Foreign Application Priority Data
Oct. 23, 2001 (WO) PCT/US01/50789

(51) Int. Cl. B60R 21/16

(52) U.S. Cl. 280/732

(57) ABSTRACT

An instrument panel (12) includes a thermoplastic base substrate (54), with at least one tear seam notch (60) pressed into a first surface (56) of the base substrate. At least one consolidated area (66) is pressed into a second surface (58) of the base substrate. The at least one consolidated area is aligned with the at least one tear seam notch. The instrument panel further includes at least one hinge area (74). Each hinge area is an area of low consolidation where a thickness of the base substrate at the low consolidation area is greater than a thickness of the base substrate at the consolidation area. The at least one tear seam notch and the at least one hinge area define at least one airbag door (78).

### BACKGROUND OF THE INVENTION

This invention relates generally to instrument panel assemblies, and more particularly to an instrument panel having a hidden airbag door.

Known instrument panel assemblies include a beam structure and at least one decorative instrument panel attached to the beam structure. Some of the decorative panels act as knee bolsters to protect the knees of vehicle occupants in the event of an impact. An instrument panel assembly is mounted inside the passenger compartment of an automobile with the beam structure attached to the automobile body, typically to the A-pillar. Known instrument panel beam structures are fabricated from steel or plastic.

A number of vehicle systems are housed within the instrument pane assembly, for example, the heating, ventilating, and air conditioning (HVAC) system, and the airbag system(s). To permit deployment of the airbag, the instrument panel includes an airbag opening covered by an airbag door. The placement of a door in the middle of a smooth surfaced instrument panel is considered as aesthetically unacceptable because the door destroys the clean aesthetic lines of an instrument panel. The deployment of the airbag forces the door open to permit the airbag to exit through the opening in the instrument panel. Typically, the door is fabricated from metal and is sometimes bent from the force of the airbag deployment. The bent airbag door does not close after the airbag deflates and could pose a hazard to the occupants in the event of a secondary impact of the occupant with the instrument panel.

Johnson Controls, Inc. has produced an instrument panel having a hidden airbag door. The molded base substrate is covered with a semi-rigid foam and a cover material. The underside of the instrument panel base substrate is scored with a laser to create a deployment seam in the shape of a door. A separate metal hinge piece is molded into the back of the door and the underside of the base substrate to permit the door to pivot open during airbag deployment. The force of the airbag deployment forces the deployment seam to separate permitting the door to be forced through the foam layer and the cover layer of the instrument panel into an open position so the airbag can exit the instrument panel. The underside of the cover layer is scored to facilitate the door breaking through the cover. The laser cutting operation and the multiple components of the airbag door increases complexity of fabrication and assembly which increases fabrication time and increases labor costs.

### BRIEF DESCRIPTION OF THE INVENTION

In one aspect, an instrument panel is provided. The instrument panel includes a thermoplastic base substrate, with at least one tear seam notch pressed into an upper surface of the base substrate. At least one consolidated area is pressed into a lower surface of the base substrate. The at least one consolidated area is aligned with the at least one tear seam notch. The instrument panel further includes at least one hinge area. Each hinge area is an area of low consolidation where a thickness of the base substrate at the low consolidation area is greater than a thickness of the base substrate at the consolidation area. The at least one tear seam notch and the at least one hinge area define at least one airbag door.

In another aspect, an instrument panel system is provided that includes an instrument panel and an airbag adjacent the instrument panel. The instrument panel includes a thermoplastic base substrate. The air bag is positioned adjacent a lower side of the base substrate. At least one tear seam notch is pressed into an upper surface of the base substrate, and at least one consolidated area is pressed into the lower surface of the base substrate. The at least one consolidated area is aligned with the at least one tear seam notch. The instrument panel further includes at least one hinge area. The at least one tear seam notch and the at least one hinge area define at least one airbag door. The tear seam notch is configured to open when the airbag deploys permitting the airbag to deploy through the instrument panel.

In another aspect, an instrument panel is provided that includes a thermoplastic base substrate, an intermediate layer adjacent an upper surface of the base substrate, and an outer layer adjacent the intermediate layer. The intermediate layer is made from a resilient material. The instrument panel further includes at least one airbag door defined by at least one tear seam notch pressed into the base substrate and at least one hinge area defined by an area of low consolidation in the base substrate. The at least one airbag door is not visible through the outer layer before an airbag deployment causes the at least one airbag door to open.

In another aspect, a method of producing an instrument panel system is provided. The instrument panel system includes an instrument panel and an airbag. The method includes press molding a thermoplastic base substrate into a predetermined shape of the instrument panel. Press molding the base substrate includes pressing at least one tear seam notch into an upper surface of the base substrate, pressing at least one consolidated area into a lower surface of the base substrate with the at least one consolidated area aligned with the at least one tear seam notch, and pressing at least one hinge area into the lower surface of the base substrate. The at least one tear seam notch and the at least one hinge area define at least one hinge door.

### BRIEF DESCRIPTION OF THE DRAWINGS

FIG. 1 is a perspective view of an instrument panel assembly in accordance with an embodiment of the present invention.

FIG. 2 is a top schematic view of a portion of the instrument panel base substrate showing an H-shaped tear seam notch pattern.

FIG. 3 is a bottom schematic view of the portion of the instrument panel base substrate shown in FIG. 2.

FIG. 4 is a cross sectional schematic view through line C-C of FIG. 3.

FIG. 5 is a cross sectional schematic view of the instrument panel through line C-C of FIG. 3 showing an intermediate layer and a cover layer.

FIG. 6 is a top schematic view of a portion of the instrument panel base substrate showing a double Y-shaped tear seam notch pattern.

FIG. 7 is a top schematic view of a portion of the instrument panel base substrate showing a U-shaped tear seam notch pattern.

### DETAILED DESCRIPTION OF THE INVENTION

An instrument panel system that includes an instrument panel with a hidden airbag door is described below in more detail. The airbag door is not visible to vehicle occupants before deployment of the airbag. The hidden airbag door opens by the force of the airbag deploying and permits the airbag to exit the instrument panel and enter the passenger compartment of the vehicle without secondary operations to the system. The opened airbag door includes smooth surfaces without sharp and/or hard edges to avoid vehicle occupant injuries. Further, the airbag door closes after the airbag deflates.

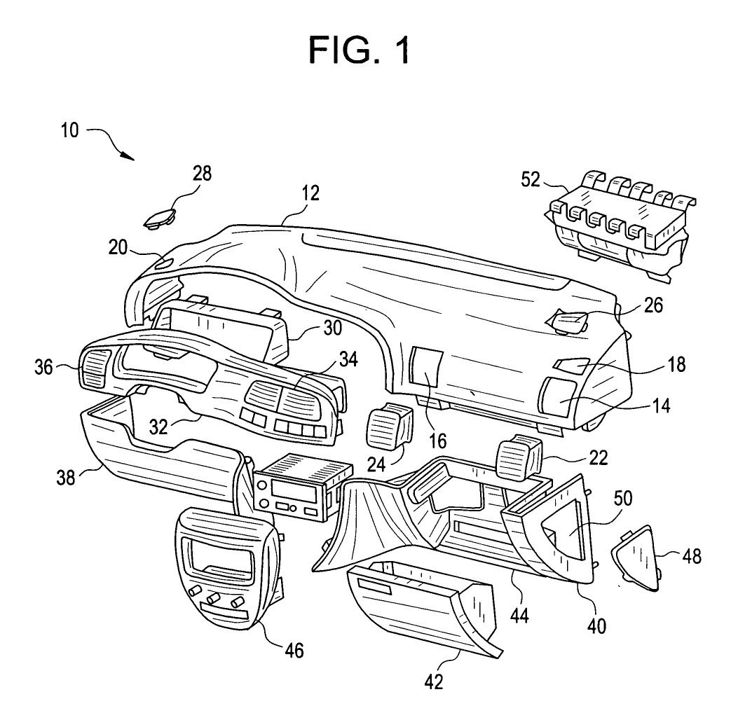

Referring to the drawings, FIG. 1 is an exploded perspective view of an instrument panel assembly 10 in accordance with all exemplary embodiment of the present invention. Instrument panel assembly 10 includes an instrument panel 12 having duct outlet openings 14, 16, 18, and 20. Vent grills 22, 24, 26, and 28 are sized to mate with openings 14, 16, 18, and 20 respectively. An instrument cluster 30 and a cluster trim plate 32 are coupled to instrument panel 12. Cluster trim plate 32 includes vent grills 34 and 36. A driver side knee bolster 38 and a glove box surround 40 are coupled to instrument panel 12. A glove box 42 attaches to a glove box hinge portion 44 of glove box surround 40. The combination of glove box surround 40 and glove box 42 act as a passenger knee bolster. A center bezel 46 is coupled to driver side knee bolster 38 and glove box surround 40. A fuse access door 48 covers a fuse access opening 50 in glove box surround 40. An airbag module 52 is mounted adjacent instrument panel 12.

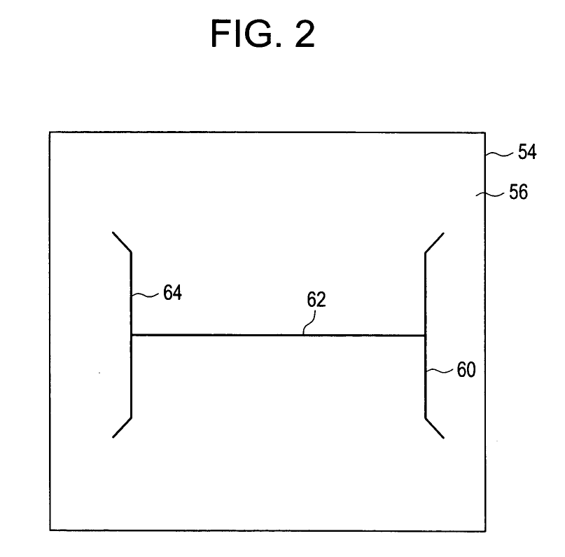

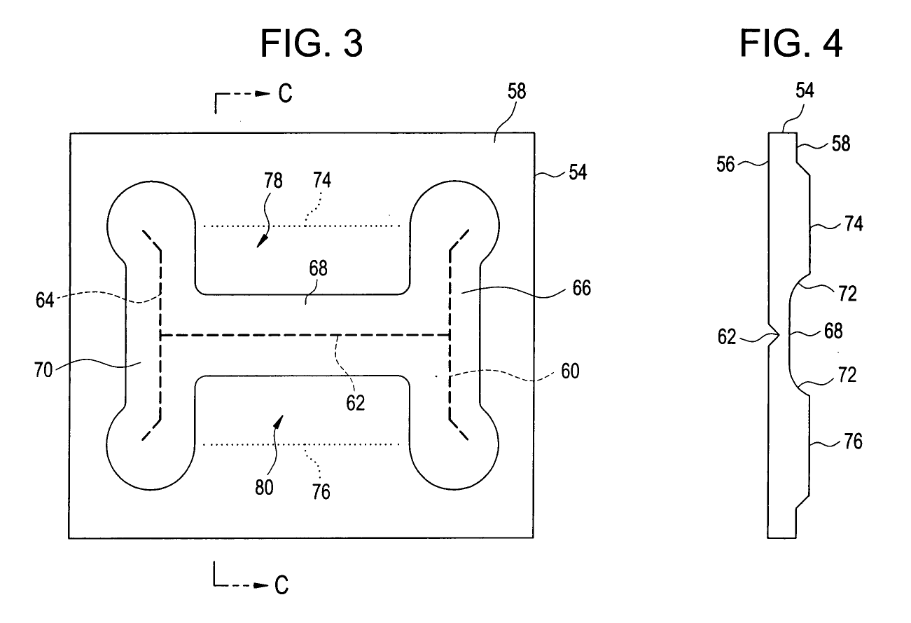

FIG. 2 is a top schematic view of a portion of a base substrate 54 of instrument panel 10, FIG. 3 is a bottom schematic view of the portion of instrument panel base substrate 54, and FIG. 4 is a cross sectional schematic view of base substrate 54 through line C-C. Referring to FIGS. 2-4, base substrate 54 includes an upper surface 56 (FIG. 2) and a lower surface 58 (FIG. 3). When instrument panel 12 is installed in a vehicle, upper surface 56 faces the passenger compartment and lower surface 58 faces the inside of instrument panel assembly 10. Base substrate 54 includes tear seam notches 60, 62, and 64 that, in this exemplary embodiment, form a substantially H-shaped pattern. Tear seam notches 60, 62, and 64 are pressed into upper surface 56 when base substrate 54 is formed into a predetermined shape of instrument panel 12 in a press molding operation. A press molding operation includes pressing a sheet of thermoplastic material between an upper and lower die having the desired shape of the final part. The pressing operation is typically performed in conjunction with applied heat. A press molding operation using heat is sometimes referred to as thermoforming. In this exemplary embodiment, tear seam notches 60, 62, and 64 have a 90-degree V-shape. In other embodiments tear seam notches 60, 62, and 64 can have other cross sectional shapes, for example, 45 degree V-shape, U-shape, conical-shaped, spherical-shaped, and box-shaped. The thickness of base substrate 54 at each tear seam notch 60, 62, and 64 is about 0.5 to about 1.0 millimeter (mm). In other embodiments the thickness of base substrate at each tear seam notch 60, 62, and 64 can be higher than 1.0 mm or lower than 0.5 mm. Higher than 1.0 millimeter thickness requires greater force to tear the seams, and lower than 0.5 millimeter thickness requires less force to tear the seams. However, thickness significantly less than 0.5 millimeter can affect the integrity of instrument panel 12.

Base substrate 54 can be can be formed from one of many thermoplastic and fiber composites materials, for example, polyethylene and fiber composites, and polypropylene and fiber composites such as AZDEL Superlite™ sheets commercially available from AZDEL, Inc.

Base substrate 54 also includes consolidation areas 66, 68, and 70 pressed into lower surface 58. The thickness of base substrate 54 is smaller in consolidation areas 66, 68, and 70 than in areas adjacent consolidation areas 66, 68, and 70. Tear seam notches 60, 62, and 64 and consolidation areas 66, 68, and 70 are aligned respectively. The periphery of consolidation areas 66, 68, and 70 include a transition portion 72. Transition portion 72 is a radiused and/or sloped portion of consolidation areas 66, 68, and 70 that provides a smooth transition from the low thickness area to a higher thickness area of base substrate 54.

Base substrate 54 further includes hinge areas 74 and 76 pressed into lower surface 58. Hinge areas 74 and 76 are areas of low consolidation where the thickness of base substrate 54 is higher than areas adjacent hinge areas 74 and 76. Tear seam notches 60, 62, and 64, and hinge areas 74 and 76 define airbag doors 78 and 80. In one embodiment, the thickness of base substrate 54 at hinge areas 74 and 76 is about 5 millimeters to about 9 millimeters. In other embodiments, the thickness of hinge areas 74 and 76 can be higher than 9 millimeters or lower than 5 millimeters. Lower than 5 millimeters thickness requires less pressure in the airbag to move the doors open but also increases the risk of the hinge breaking. Greater than 9 millimeters thickness will usually require higher airbag pressure to move the doors open, but decreases of the hinge breaking. High airbag pressures can be a hazard to vehicle occupants.

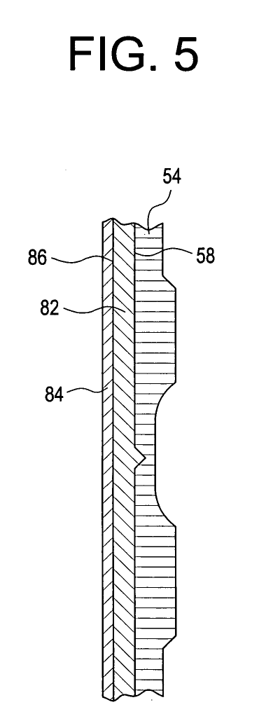

FIG. 5 is a cross sectional schematic view of instrument panel 12 through line C-C of FIG. 3. Instrument panel 12 includes an intermediate layer 82 on outer surface 56 of base substrate 54 and a cover layer 84 on outer surface 86 of intermediate layer 82. Intermediate layer 82 is formed from a resilient material, for example, a foam material. The resilient material provides protection to vehicle occupants in impact events. Cover layer 84 is formed from any suitable decorative material, for example, a thermoplastic material, leather, fabric, and the like. With the application of intermediate layer 82 and cover layer 84 to base substrate 54, airbag doors 78 and 80 are not visible to a vehicle occupant. In the exemplary embodiment, intermediate layer 82 and cover layer 84 do not contain tear seam scores or notches to aid the opening of the airbag doors. In other embodiments, at least one of intermediate layer 82 and cover layer 84 also include tear seam notches.

In operation, during an airbag deployment event, airbag 52 inflates and imparts a force on instrument panel 12. The force causes tear seam notches 60, 62, and 64 to open and causes airbag doors to move to an open position by breaking through intermediate layer 82 and cover layer 84. With airbag doors 78 and 80 in an open position, airbag 52 can fully inflate through instrument panel 12. After airbag 52 deflates, airbag doors 78 and 80 move toward a closed position because of the ductile properties of base substrate 54. Open airbag doors 78 and 80 have smooth surfaces without sharp/hard edges to avoid vehicle occupant injuries.

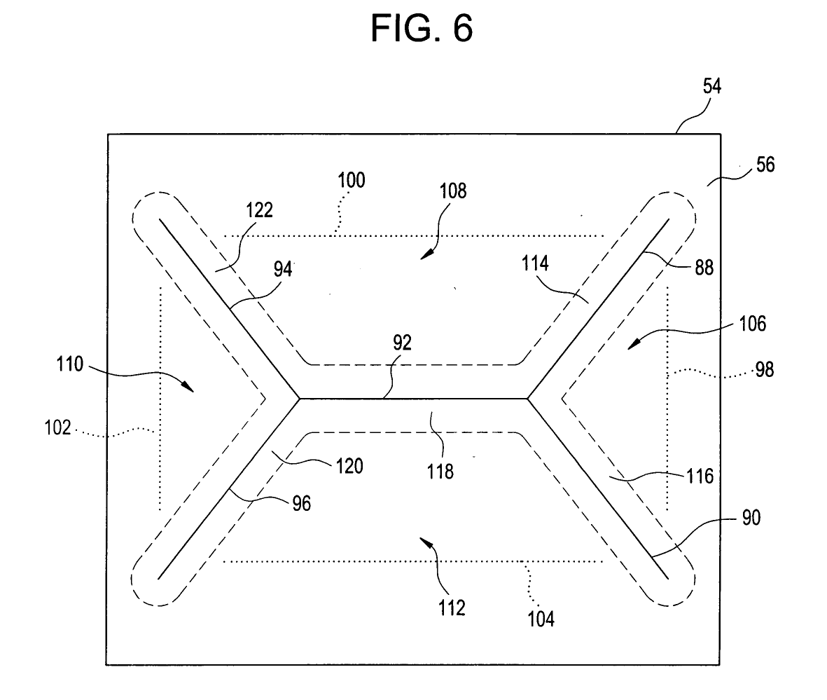

FIG. 6 is a top schematic view of a portion of instrument panel base substrate 54 in accordance with another embodiment of the present invention. Base substrate 54 includes tear seam notches 88, 90, 92, 94, and 96 pressed into base substrate upper surface 56. Tear seam notches 88, 90, 92, 94, and 96 are arranged in a double-Y pattern. Hinge areas 98, 100, 102, and 104 are pressed in base substrate lower surface 58. Tear seam notches 88, 90, 92, 94, and 96 and hinge areas 98, 100, 102, and 104 define airbag doors 106, 108, 110, and 112. Base substrate 54 also includes consolidation areas 114, 116, 118, 120, and 122 pressed into lower surface 58. The thickness of base substrate 54 is smaller in consolidation areas, 114, 116, 118, 120 and 122 than in areas adjacent consolidation areas 114, 116, 118, 120, and 122. Tear seam notches 88, 90, 92, 94, and 96 and consolidation areas 114, 116, 118, 120 and 122 are aligned respectively.

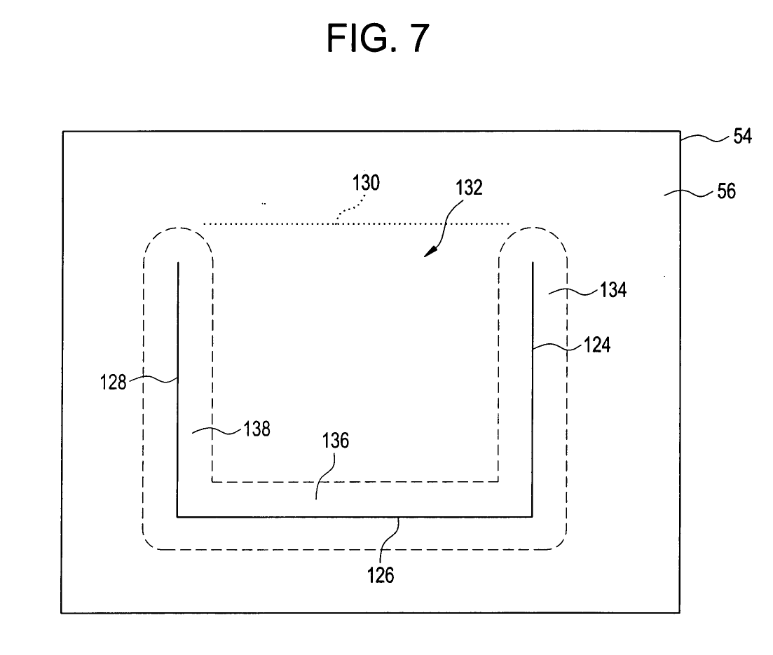

FIG. 7 is a top schematic view of a portion of instrument panel base substrate 54 in accordance with another embodiment of the present invention. Base substrate 54 includes tear seam notches 124, 126 and 128 pressed into base substrate upper surface 56. Tear seam notches 124, 126 and 128 are arranged in a U-shaped pattern. Hinge area 130 is pressed in base substrate lower surface 58. Tear seam notches 124, 126 and 128 and hinge area 130 define airbag door 132. Base substrate 54 also includes consolidation areas 134, 136, and 138 pressed into lower surface 58. The thickness of base substrate 54 is smaller in consolidation areas 134, 136, and 138 than in areas adjacent consolidation areas 134, 136, and 138. Tear seam notches 124, 126 and 128 and consolidation areas 134, 136, and 138 are aligned respectively.

Of course, the arrangement of tear seam notches in instrument panel base substrate are not limited to the exemplary embodiments shown in FIGS. 2, 3, 6, and 7 and described above. Other suitable tear seam notch configurations can be used. Some other suitable, non-limiting, tear seam notch configurations include star, circle, and oval. Also, the tear seam notches can include curves. Further, the above-described exemplary embodiments have the tear seam notches pressed into base substrate upper surface 56. In alternative embodiments, the tear seam notches are pressed into base substrate lower surface 58.

Further, the above-described exemplary embodiments are directed to hidden airbag doors in instrument panels. In alternate embodiments, other vehicle components include hidden airbag doors, for example door panels and trim panels.

While the invention has been described in terms of various specific embodiments, those skilled in the art will recognize that the invention can be practiced with modification within the spirit and scope of the claims.

What is claimed is:

1. An instrument panel (12) comprising:
a thermoplastic base substrate (54) having a first surface (56) and a second surface (58);
at least one tear seam notch (60) pressed into said first surface of said base substrate;
at least one consolidated area (66) pressed into said second surface of said base substrate, said at least one consolidated area aligned with said at least one tear seam notch;
at least one hinge area (74) comprising an area of low consolidation wherein a thickness of said base substrate at said low consolidation area is greater than a thickness of said base substrate at said at least one consolidation area, said at least one tear seam notch and said at least one hinge area defining at least one airbag door (78).

2. An instrument panel (12) in accordance with claim 1 wherein a width of said at least one consolidated area (66) is equal to or greater than a width of said at least one tear seam notch (60).

3. An instrument panel (12) in accordance with claim 1 wherein each said consolidation area (66) comprises a transition portion (72) located around the periphery of each said consolidation area.

4. An instrument panel (12) in accordance with claim 3 wherein said transition portion (72) comprises a radius of curvature.

5. An instrument panel (12) in accordance with claim 1 wherein said base substrate (54) is compression molded into a predetermined shape of said instrument panel.

6. An instrument panel (12) in accordance with claim 1 further comprising an intermediate layer (82) adjacent said first surface (56) of said base substrate (54), said intermediate layer comprising a resilient material.

7. An instrument panel (12) in accordance with claim 6 wherein said resilient material comprises a foam material.

8. An instrument panel (12) in accordance with claim 6 further comprising an outer layer (84) adjacent said intermediate layer (82).

9. An instrument panel (12) in accordance with claim 1 wherein a thickness of said base substrate (54) at said hinge low consolidation area (66) is greater than a thickness of said base substrate at an area adjacent said hinge area (74).

10. An instrument panel system (10) comprising an instrument panel (12) and an airbag (52), said air bag positioned adjacent said instrument panel, said instrument panel comprising:
a thermoplastic base substrate (54) having a first surface (56) and a second surface (58), said air bag positioned adjacent said second surface of said base substrate;
at least one tear seam notch (60) pressed into said first surface of said base substrate;
at least one consolidated area (66) pressed into said second surface of said base substrate, said at least one consolidated area aligned with said at least one tear seam notch;
at least one hinge area (74) comprising an area of low consolidation wherein a thickness of said base substrate at said low consolidation area is greater than a thickness of said base substrate at said at least one consolidation area, said at least one tear seam notch and said at least one hinge area defining at least one airbag door (78), said tear seam notch configured to open when said airbag deploys permitting said airbag to deploy through said instrument panel.

11. An instrument panel system (10) in accordance with claim 10 wherein a width of said at least one consolidated area (66) is equal to or greater than a width of said at least one tear seam notch (60).

12. An instrument panel system (10) in accordance with claim 10 wherein each said consolidation area (66) comprises a transition portion (72) located around the periphery of each said consolidation area.

13. An instrument panel system (10) in accordance with claim 12 wherein said transition portion (72) comprises a radius of curvature.

14. An instrument panel system (10) in accordance with claim 10 wherein said base substrate (54) is compression molded into a predetermined shape of said instrument panel (12).

15. An instrument panel system (10) in accordance with claim 10 wherein said instrument panel (12) further comprises an intermediate layer (82) adjacent said first surface (56) of said base substrate (54), said intermediate layer comprising a resilient material.

16. An instrument panel (12) in accordance with claim 15 wherein said instrument panel further comprises an outer layer (84) adjacent said intermediate layer (82), said at least one tear seam notch (60) is not visible through said outer layer before deployment of said airbag (52).

17. An instrument panel (12) comprising:
a thermoplastic base substrate (54) having a first surface (56) and a second surface (58);
an intermediate layer (82) adjacent said first surface of said base substrate, said intermediate layer comprising a resilient material;
an outer layer (84) adjacent said intermediate layer;
at least one airbag door (78) defined by at least one tear seam notch (60) pressed into said base substrate and at least one hinge area (74) comprising an area of low consolidation in said base substrate, said at least one airbag door not visible through said outer layer before an airbag (52) deployment causes said at least one airbag door to open.

18. An instrument panel (12) in accordance with claim 17 wherein said at least one tear seam notch (60) is pressed into said first surface (56) of said base substrate (54).

19. An instrument panel (12) in accordance with claim 17 further comprising at least one consolidated area (66) pressed into said second surface (58) of said base substrate (54), said at least one consolidated area aligned with said at least one tear seam notch (60).

20. An instrument panel (12) in accordance with claim 19 wherein a thickness of said base substrate (54) at said hinge low consolidation area (74) is greater than a thickness of said base substrate at said at least one consolidation area (66).

21. An instrument panel (12) in accordance with claim 19 wherein a thickness of said base substrate (54) at said hinge low consolidation area (74) is greater than a thickness of said base substrate at an area adjacent said hinge area.

22. A method of producing an instrument panel system (10) comprising an instrument panel (12) and an airbag (52), said method comprising press molding a thermoplastic base substrate (54) having a first surface (56) and a second surface (58) into a predetermined shape of the instrument panel, wherein press molding the base substrate comprises:
pressing at least one tear seam notch (60) into the base substrate;
pressing at least one consolidated area (66) into the second surface of the base substrate, the at least one consolidated area aligned with the at least one tear seam notch;
pressing at least one hinge area (74) into the second surface of the base substrate, each hinge area comprising an area of low consolidation wherein a thickness of the base substrate at the low consolidation area is greater than the thickness of the base substrate at a consolidation area, the at least one tear seam notch and the at least one hinge area defining at least one airbag door.

23. A method in accordance with claim 22 wherein a width of the at least one consolidated area (66) is equal to or greater than a width of the at least one tear seam notch (60).

24. A method in accordance with claim 22 wherein each consolidation area (66) comprises a transition portion (72) located around the periphery of the consolidation area.

25. A method in accordance with claim 22 wherein a thickness of the base substrate (54) at the hinge low consolidation area (74) is greater than a thickness of the base substrate at the at least one consolidation area (66).

26. A method in accordance with claim 22 further comprising forming an intermediate layer (82) adjacent the first surface (56) of the base substrate (54), the intermediate layer comprising a resilient material.

27. A method in accordance with claim 26 further comprising forming an outer layer (84) adjacent the intermediate layer (82).

28. A method in accordance with claim 26 further comprising positioning the airbag (52) adjacent the at least one airbag door (78).

29. A method in accordance with claim 22 wherein pressing at least one tear seam notch (60) into the base substrate (54) comprises pressing at least one tear seam notch into the first surface (56) of the base substrate.

30. A method in accordance with claim 22 wherein pressing at least one tear seam notch (60) into the base substrate (54) comprises pressing at least one tear seam notch into the second surface (58) of the base substrate.

31. A thermoplastic panel comprising at least one hidden airbag door (78), said panel further comprising:
a thermoplastic base substrate (54) having a first surface (56) and a second surface (58);
at least one tear seam notch (60) pressed into said base substrate;
at least one consolidated area (66) pressed into said second surface of said base substrate, said at least one consolidated area aligned with said at least one tear seam notch;
at least one hinge area (74) comprising an area of low consolidation wherein a thickness of said base substrate at said low consolidation area is greater than a thickness of said base substrate at said at least one consolidation area, said at least one tear seam notch and said at least one hinge area defining at least one airbag door (78).

32. A thermoplastic panel in accordance with claim 31 wherein a width of said at least one consolidated area (66) is equal to or greater than a width of said at least one tear seam notch (60).

33. A thermoplastic panel in accordance with claim 31 wherein at least one tear seam notch (60) is pressed into said first surface (56) of said base substrate (54).

34. A thermoplastic panel in accordance with claim 31 wherein at least one tear seam notch (60) is pressed into said second surface (58) of said base substrate (54).

35. A thermoplastic panel in accordance with claim 31 further comprising an intermediate layer (82) adjacent said first surface (56) of said base substrate (54), said intermediate layer comprising a resilient material.

36. A thermoplastic panel in accordance with claim 35 further comprising an outer layer (84) adjacent said intermediate layer (82).

37. A thermoplastic panel in accordance with claim 31 wherein a thickness of said base substrate (54) at said hinge low consolidation area (74) is greater than a thickness of said base substrate at an area adjacent said hinge area.
